(19) United States
(12) Patent Application Publication
(10) Pub. No.: US 2026/0257650 A1
(43) Pub. Date: Sep. 3, 2026

(54) ADAPTER FOR MOUNTING A BLADE ON A WIPER ARM

(71) Applicant: VALEO SYSTÈMES D'ESSUYAGE, LE MESNIL SAINT DENIS (FR)

(72) Inventors: Thomas CAETANO, La Verriere (FR); Stephane HOUSSAT, La Verriere (FR); Vincent GAUCHER, La Verriere (FR)

(73) Assignee: VALEO SYSTEMES D'ESSUYAGE, La Verriere (FR)

(21) Appl. No.: 19/162,164

(22) PCT Filed: Mar. 5, 2024
(86) PCT No.: PCT/EP2024/055674

§ 371 Date: Sep. 4, 2025

(30) Foreign Application Priority Data
Mar. 6, 2023 (FR) FR2302055

(51) Int. Cl. B60S 1/40

(52) U.S. Cl. CPC B60S 1/4087; B60S 2001/4096

(57) ABSTRACT

An adapter for assembling a wiper blade on a wiper arm, the adapter includes a flexible tab bearing a locking button, where an end of the locking button is extended laterally by at least one locking lip, a retaining edge of which extends in a longitudinal direction of the adapter so as to cooperate with a lateral border of an opening in a yoke of the wiper arm so as to lock the assembly of the adapter in the yoke.

### TECHNICAL FIELD

The present invention relates to an adapter for assembling a wiper blade to a wiper arm. A further subject of the invention is a wiper device comprising a wiper arm, a wiper blade and an adapter.

### BACKGROUND OF THE INVENTION

Motor vehicles are commonly fitted with wiper systems that are intended to clean their glazed surfaces, and in particular their windshield. Such wiper systems comprise a wiper arm and a wiper blade driven by said arm. The wiper arm is connected to an electric motor of the vehicle and the wiper blade comprises at least one wiper rubber suitable for coming into contact with the glazed surface to be wiped. In order to be able to drive the wiper blade, the wiper is assembled to the wiper arm via an adapter.

There are various kinds of arms, such as hook arms, arms with a lateral pivot pin, arms with longitudinal clip-fastening, rod arms, vertically locking arms, etc.

An adapter is thus specifically configured to cooperate with vertically locking arms.

Such an adapter comprising a flexible tab bearing a locking button configured to lock the assembly of the wiper blade to a wiper arm, notably to retain the adapter in the yoke when the blade is pulled downward, is known.

To do so, the front of the locking button has a locking lip, a retaining edge of which extends in a transverse direction. The locking lip cooperates with a front border of an opening provided in the upper surface of the yoke so as to retain the adapter in the yoke.

A drawback of such system is that there is a large dimensional variation in the existing arms selection. In fact, the adapter cannot be compatible with the full variety of yokes present on the market. Indeed, it is noted that the opening provided in the yoke, which allows the locking button to lock the adapter to the arm, can have a longitudinal position which differs from one yoke to another.

If the opening is offset toward the front of the yoke, the locking lip of the button may no longer be able to hook the yoke, preventing the correct locking of the assembly.

If the opening is offset toward the rear of the yoke, the locking lip may significantly interfere with the front edge of the opening, preventing the locking button from completely passing up through the opening.

It is not possible to simply offset by construction the locking button of the adapter toward the front or the rear without necessarily adversely affecting one or the other of the two situations described above.

### SUMMARY OF THE INVENTION

One of the aims of the present invention is to propose an adapter which enables the correct locking of the locking button regardless of the longitudinal position of the opening in the yoke.

To this end, a subject of the invention is an adapter for assembling a wiper blade to a wiper arm, the adapter comprising a flexible tab bearing a locking button, characterized in that an end of the locking button is extended laterally by at least one locking lip, a retaining edge of which extends in a longitudinal direction of the adapter so as to cooperate with a lateral border of an opening in a yoke of the wiper arm so as to lock the assembly of the adapter in the yoke.

The advantage is that the adapter no longer utilizes the front border of the opening in the yoke in order to hook the lip of the locking button. The locking of the button becomes independent of the longitudinal position of the opening in the yoke, thus making it possible to ensure correct locking of the adapter despite the dimensional variations of the yokes of wiper arms.

The adapter may also have one or more of the features that are described below, taken alone or in combination.

The flexible tab extends, for example, from a flank of the body of the adapter to the center of a rear opening provided in the body, so as to allow the locking button to tilt to the side about a longitudinal axis.

The flexible tab extends, for example, from the flank of the body of the adapter which is located on the same side as the one where the locking lip is arranged.

An upper surface of the locking lip may have a rounded shape configured to bring about gradual pivoting of the locking button when it is inserted into the opening in the yoke.

The entire upper surface of the locking button may extend in a continuous and rounded manner.

The retaining edge of the locking lip is, for example, planar.

The locking button may have a cap extending from a front face of the locking button so as to wedge the longitudinal positioning of the locking button.

The body of the adapter extends, for example, at its front longitudinal end with a head forming a stop for the mounting of the adapter by a translation movement in the yoke of the wiper arm in the longitudinal direction.

The body of the adapter may also have two wings extending on either side of the head, the wings being configured to cooperate with a respective lateral notch of the yoke in order to clip the adapter to the yoke.

A further subject of the invention is a wiper device comprising a wiper arm and a wiper blade, characterized in that it comprises an adapter as described above in order to connect the wiper blade to the end of the wiper arm.

### BRIEF DESCRIPTION OF THE DRAWINGS

Other advantages and features will become apparent from reading the following description of a particular, but in no way limiting, embodiment of the invention, and from the appended drawings, in which:

FIG. 1 is a perspective view of a first exemplary embodiment of a wiper device.

FIG. 2 is an enlarged, partial view of the wiper device in FIG. 1.

FIG. 3 is a perspective view of a wiper arm of the wiper device in FIG. 1.

FIG. 4 is a perspective view of an adapter for the wiper device in FIG. 1.

FIG. 5 is a perspective view from substantially below of the adapter in FIG. 4.

FIG. 6 is a top view of the adapter in FIG. 4.

FIG. 7 is a rear view of the adapter in FIG. 4.

FIG. 8 is a section view along a transverse plane (X, Z) of the adapter assembled to the yoke of the wiper device in FIG. 1.

FIG. 9 is a top view of elements in FIG. 8 while being removed.

FIG. 10 is a perspective view of a second exemplary embodiment of a wiper device.

FIG. 11 is a perspective view from substantially below of the adapter for the wiper device in FIG. 10.

FIG. 12 shows a third exemplary embodiment of the adapter.

In these figures, identical elements bear the same reference numbers.

### DETAILED DESCRIPTION OF THE INVENTION

The following embodiments are examples. Although the description refers to one or more embodiments, this does not necessarily mean that each reference relates to the same embodiment, or that the features apply only to a single embodiment. Individual features of different embodiments may also be combined or interchanged to provide other embodiments without departing from the scope of the invention, as defined by the claims.

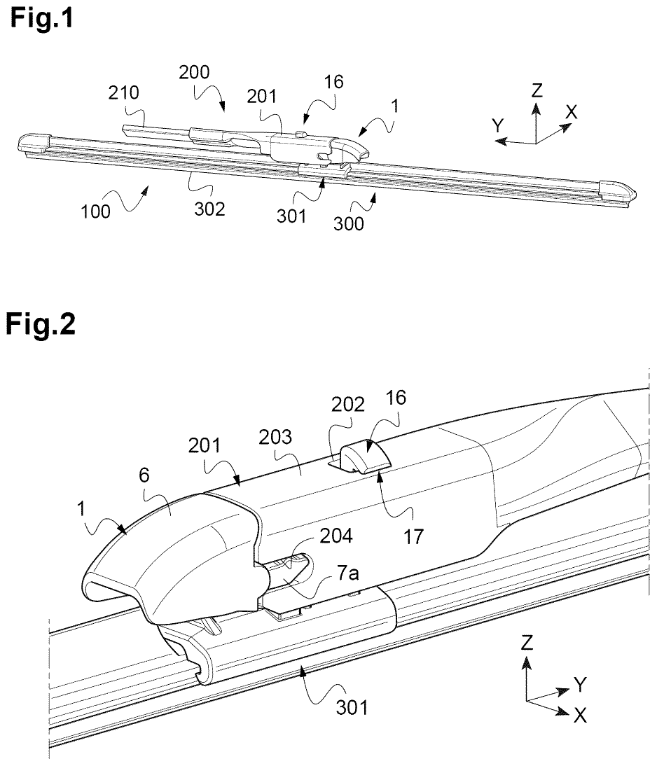

In the remainder of the description, the longitudinal direction Y, the vertical direction Z and the transverse direction X indicated in particular in FIG. 1 by the trihedral frame of reference (X, Y, Z) that is fixed with respect to the adapter 1 will be adopted in a non-limiting manner. The longitudinal direction Y corresponds to the main direction in which the adapter 1 extends. The transverse direction X corresponds to the direction of the axis of rotation between the adapter and the connector of the wiper blade. The vertical direction Z and transverse direction X are perpendicular to the longitudinal direction Y and perpendicular to one another.

The “front” of the adapter refers to the side where the head of the adapter is located and the “rear” refers to the opposite side.

The terms “upper” and “top” refer to the side of the adapter that is located on the side of the yoke and the terms “lower” and “bottom” refer to the opposite side.

The terms “clip/unclip”, “clip-fasten/unfasten” and “snap-fasten/unfasten” are understood to mean a removable assembly produced by elastic deformation of one element in or on another element.

FIG. 1 shows a first exemplary embodiment of a wiper device 100 comprising a wiper arm 200 intended to be connected to a motorized wiper mechanism of a vehicle, for cleaning a glazed surface of the vehicle, for example a windshield.

The wiper device 100 also comprises a wiper blade 300 connected to a yoke 201 at the end of the wiper arm 200 by means of an adapter 1.

The adapter 1 makes it possible to assemble the arm 200 to a connector 301 of the wiper blade 300 in an articulated manner. The connector 301 is an element of the blade 300 surmounting a wiper rubber 302 of the blade 300 in the middle thereof.

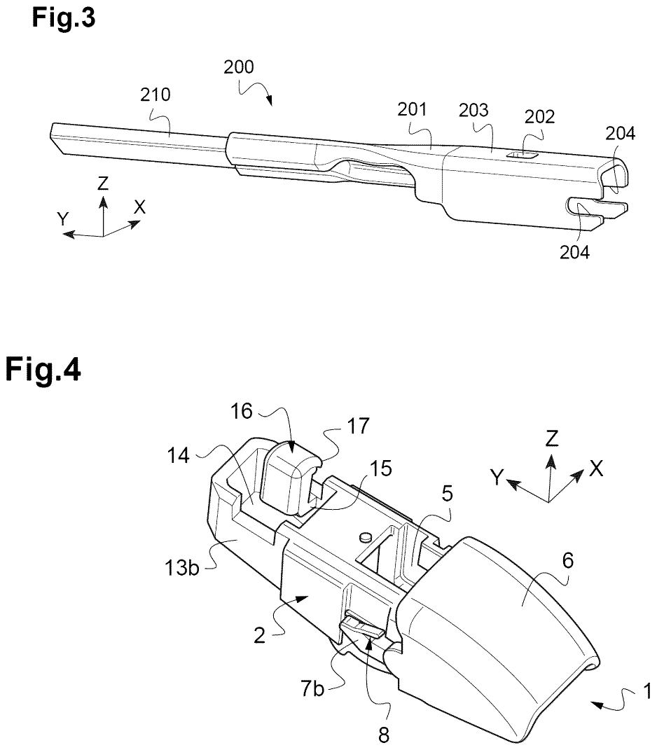

As can best be seen in FIG. 2 and FIG. 3, the yoke 201 is fastened to the end of a rod 210 of the blade arm 200. This yoke 201 has a body extending mainly in a longitudinal direction Y and has, at its end, a “U”-shaped cross section (in the plane (X, Z)). The U-shape of the yoke 201 has a planar upper wall 203 and two lateral walls extending from parallel edges of the upper wall.

An opening 202 is provided in the upper wall 203. The opening 202 has, for example, a rectangular shape, such as square, the corners being able to be rounded.

At least one lateral notch 204 is provided in each lateral wall of the U, for example two lateral notches 204 are provided in each wall, for example facing one another (FIG. 3). These lateral notches 204 are open on the side of the front end of the yoke 201.

The wiper device 100 is said to be “vertically locking”, since the adapter 1 is inserted into the yoke 201 of the arm by a translation movement in the longitudinal direction Y and is locked in position by a locking button 16 of the adapter 1 that can be actuated from the upper wall 203 of the yoke 201.

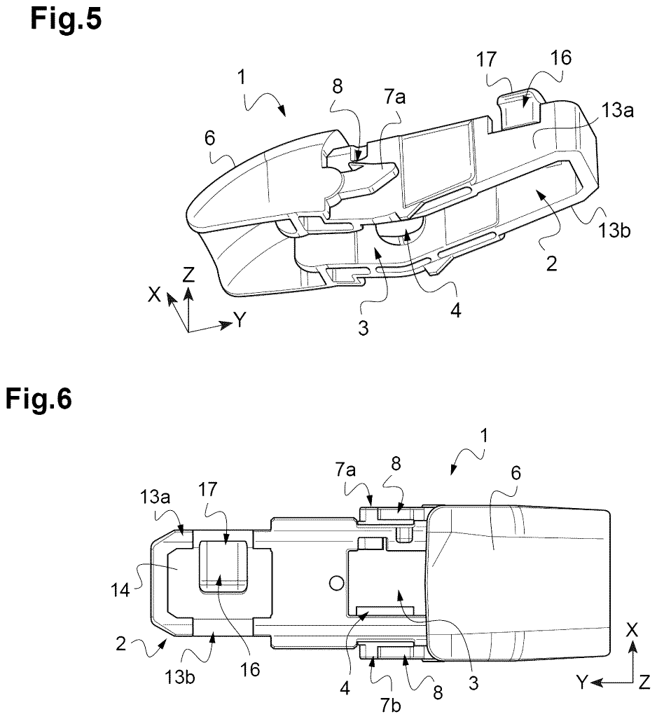

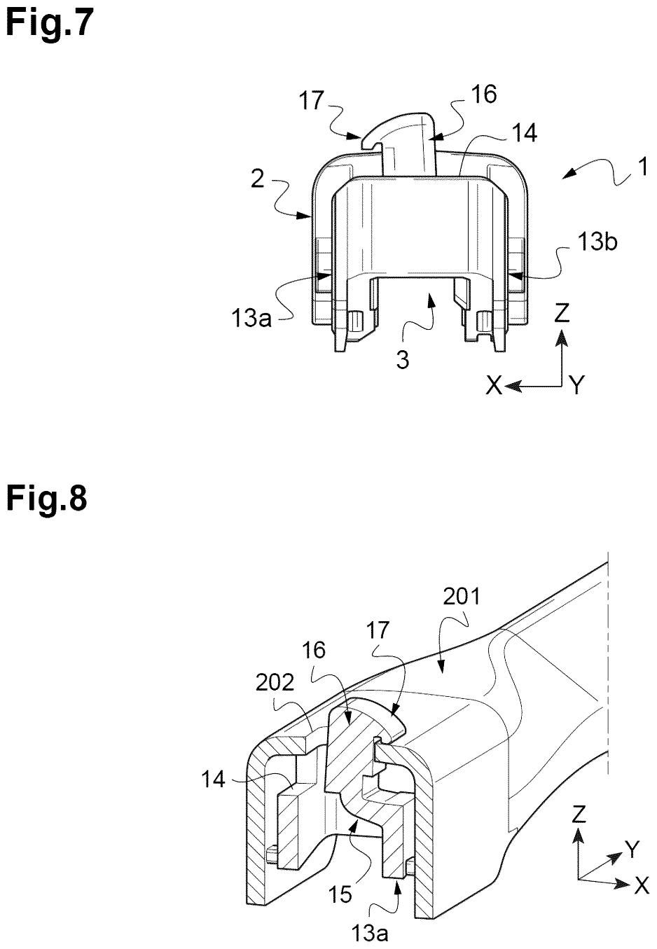

FIG. 4, FIG. 5, FIG. 6 and FIG. 7 show the adapter 1 in more detail.

The adapter 1 is in one piece. It has a body extending mainly in the longitudinal direction Y.

In order to connect the adapter 1 to the blade 300, the body 2 of the adapter 1 comprises a connector housing 3 (FIG. 5) allowing it to receive the connector 301 of the wiper blade 300 to which it is retained for example by snap-fastening, notably by means of pivot elements of the adapter 1 and of the connector 301, or by means of pivot elements of the adapter 1 and of the connector 301, such as a pin.

The connector housing 3 of the adapter 1 has a “U”-shaped cross section (in the plane (X, Z)) with outer dimensions that are complementary to those of the inner housing of the yoke 201 and inner dimensions that are complementary to the top of the connector 301 of the wiper blade 300.

The pivot elements of the adapter 1, for example of the male and female type, are arranged in the connector housing 3 so as to cooperate with complementary pivot elements of the connector 301 of the wiper blade 300 so as to form a pivot connection. The rotation between the adapter 1 and the connector 301 is realized about a rotation axis parallel to the transverse direction X.

According to one exemplary embodiment of the pivot elements, the adapter 1 comprises, for the one part, a cylindrical stud 4 configured to cooperate with a circular orifice in the connector 301, and, for the other part, a cavity 5 configured to cooperate with a cylindrical stud of the connector 301, the cylindrical stud 4 and the cavity 5 of the adapter 1 being formed in the parallel and opposite walls of the connector housing 3 (FIG. 4 and FIG. 5).

The body 2 of the adapter 1 extends at its front longitudinal end with a head 6. The head 6 of the adapter 1 has dimensions in the directions X, Y, Z that are larger than the lateral and upper walls of the connector housing 3. The head 6 forms a stop for mounting the adapter 1 by a translation movement in the yoke 201 of the wiper arm 200 in the longitudinal direction Y (FIG. 2).

The body 2 of the adapter 1 also has two wings 7a, 7b extending on either side of the head 6, at the rear of the head 6 (FIG. 4 and FIG. 5).

Each wing 7a, 7b extends rearward in the longitudinal direction Y and bears a respective elastic finger 8. The wings 7a, 7b are configured to cooperate with a respective lateral notch 204 of the yoke 201 in order to clip the adapter 1 to the yoke 201 of the arm 200 (FIG. 2).

The body 2 of the adapter 1 extends at the opposite longitudinal end of the head 6 for example with two flanks 13a, 13b in the continuation of the lateral walls of the connector housing 3, the flanks 13a, 13b being joined at the rear of the adapter 1 by a transverse wall. The flanks 13a, 13b, the transverse wall and the connector housing 3 delimit a rear opening 14 (FIG. 4).

The adapter 1 also comprises a flexible tab 15 extending in the rear opening 14 thus provided in the body 2 of the adapter 1, at the rear of the connector housing 3. The flexible tab 15 bears a locking button 16 at its end.

An end of the locking button 16 is extended laterally by at least one locking lip 17, a retaining edge of which extends in a longitudinal direction Y of the adapter 1 so as to cooperate with a lateral border of the opening 202 in the yoke 201 of the wiper arm 200 so as to lock the assembly of the adapter 1 in the yoke 201.

The retaining edge of the locking lip 17 may be planar on the lower face. It forms a stop for the yoke 201 in the vertical direction Z, thus allowing the locking button 16 to be clip-fastened to the yoke 201 and therefore the assembly of the adapter 1 to be locked with the wiper arm 200.

The length of the locking lip 17 may be shorter, longer or the same length as the length of the locking button 16 in the longitudinal direction Y.

The locking button 16 is extended by a single locking lip 17 in the figures, but it is also possible to provide for the locking button 16 to extend with a plurality of locking lips, such as for example with two locking lips (see FIG. 12).

The flexible tab 15 extends from a flank 13a of the body 2 of the adapter 1 to the center of the rear opening 14 so as to allow the locking button to tilt to the side, about a longitudinal axis Y, by deformation of the flexible tab 15 (FIG. 6 and FIG. 8).

The flexible tab 15 extends, for example, so as to have the locking button 16 above the rear opening 14 and at least partially above an upper wall of the body 2 of the adapter 1 (FIG. 7).

According to one exemplary embodiment, the flexible tab 15 extends from that flank 13a of the body 2 of the adapter 1 which is located on the same side as the one where the locking lip 17 is arranged, such that lateral pressing on the locking button 16, with the finger of the user, causes it to tilt about the longitudinal axis, in the opening 202 in the yoke 201, so as to disengage the locking lip 17 and release the adapter 1.

According to one exemplary embodiment that is better visible in FIG. 7, the upper surface of the locking lip 17 has a rounded shape or a shape with an inclined plane (upper ramp), configured to bring about gradual pivoting of the locking button 16 when it is inserted into the opening 202 in the yoke 201. The locking button 16 is repositioned by elasticity of the flexible tab 15 to the locking position once the locking lip 17 has passed through the opening 202.

The entire upper surface of the locking button 16 extends for example in a continuous and rounded manner.

When mounting the wiper blade 300 in the yoke 201 of the wiper arm 200, the user moves the adapter 1 toward the yoke 201, positioning the adapter 1 at an angle so as to be able to introduce it into the yoke 201, notably in order to introduce the wings 7a, 7b of the adapter 1 into the lateral cavities 204 of the yoke 201.

Then, the user lifts up the rear of the adapter 1 in the yoke 201, and this causes the automatic clipping of the adapter 1 in the yoke 201 due to the gradual pivoting of the locking button 16 about the longitudinal axis as a result of the upper surface of the locking button 16 coming into contact with the yoke 201, allowing it to pass up through the opening 202. The wings 7a, 7b are inserted into a respective lateral notch 204 of the yoke 201.

When the yoke 201 comes into abutment against the head 6 of the adapter 1, the wings 7a, 7b are engaged in the lateral notches 204, clip-fastening the adapter 1 to the yoke 201 of the arm 200. The locking button 16 is repositioned by elasticity of the flexible tab 15, engaging the locking button 16 by elastic snap-fastening in the corresponding opening 202 in the yoke 201. The retaining edge of the locking lip 17 of the adapter 1 forms a stop for the yoke 201 in the vertical direction Z, thus locking the assembly of the adapter 1 with the yoke 201 of the wiper arm 200.

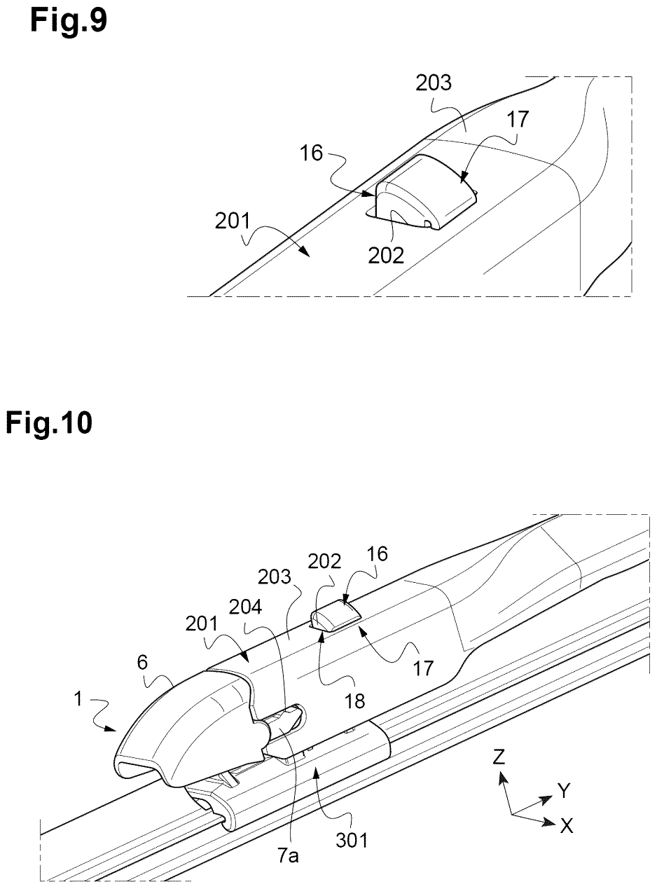

In order to remove the adapter 1, lateral pressing on the locking button 16 with the finger of the user causes the locking button 16 to tilt to the side about the longitudinal axis in the opening 202, thus disengaging the adapter 1 from the yoke 201 (FIG. 9).

This disengagement is no longer realized by rearward tilting of the locking button of the adapter of the prior art, where the flexible tab brings about, via vertical pressing, the lowering and a slight longitudinal retraction of the button.

The advantage is that the adapter 1 no longer utilizes the front border of the opening 202 in the yoke 201 in order to hook the lip 17 of the locking button 16. The locking of the button 16 becomes independent of the longitudinal position of the opening 202 in the yoke 201, thus making it possible to ensure correct locking of the adapter 1 despite the dimensional variations of the yokes 201 of wiper arms 200.

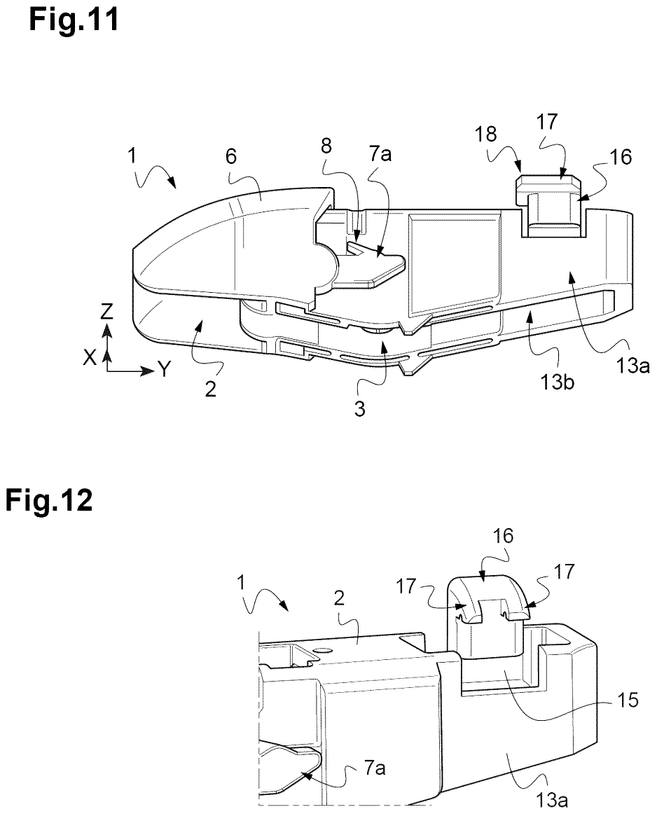

FIG. 10 and FIG. 11 show a wiper device 100 according to another exemplary embodiment.

In this example, the locking button 16 of the adapter 1 has a cap 18 extending from the front face of the locking button 16, that is to say in the transverse direction X.

The cap 18 and the locking lip 17 are joined for example in a continuous manner along the two adjacent peripheral sides of the locking button 16.

Similarly, the upper surface of the locking button 16 extends for example in a continuous and rounded manner up to the cap 18 and the locking lip 17.

The cap 18 is dimensioned so as to not cooperate or interact with the front border of the opening 202 in the yoke 201 when mounting the adapter 1 in the yoke 201. On the other hand, once the adapter 1 has been mounted, the cap 18 makes it possible, when the wiper blade 300 is urged toward the front of the arm 200, for the yoke 201 to be wedged under this cap 18 which thus wedges the longitudinal positioning of the locking button 16.

The other features of this exemplary embodiment are similar to those of the first exemplary embodiment.

What is claimed is:

1. An adapter for assembling a wiper blade to a wiper arm, the adapter comprising a flexible tab bearing a locking button,
wherein an end of the locking button is extended laterally by at least one locking lip, a retaining edge of which extends in a longitudinal direction of the adapter so as to cooperate with a lateral border of an opening in a yoke of the wiper arm so as to lock the assembly of the adapter in the yoke.

2. The adapter according to claim 1, wherein the flexible tab extends from a flank of the body of the adapter to the center of a rear opening, provided in the body, so as to allow the locking button to tilt to the side about a longitudinal axis.

3. The adapter according to claim 2, wherein the flexible tab extends from the flank of the body of the adapter which is located on the same side as the one where the locking lip is arranged.

4. The adapter according to claim 1, wherein an upper surface of the locking lip has a rounded shape configured to bring about gradual pivoting of the locking button when it is inserted into the opening in the yoke.

5. The adapter according to claim 4, wherein all of the upper surface of the locking button extends in a continuous and rounded manner.

6. The adapter according to claim 1, wherein the locking lip has a planar retaining edge.

7. The adapter according to claim 1, wherein the locking button has a cap, extending from a front face of the locking button so as to wedge the longitudinal positioning of the locking button.

8. The adapter according to claim 1, wherein the body of the adapter extends in a front longitudinal end with a head forming a stop for the mounting of the adapter by a translation movement in the yoke of the wiper arm in the longitudinal direction.

9. The adapter according to claim 8, wherein the body of the adapter also has two wings, extending on either side of the head, the wings being configured to cooperate with a respective lateral notch of the yoke in order to clip the adapter to the yoke.

10. A wiper device comprising a wiper arm and a wiper blade, wherein the wiper blade includes an adapter to connect the wiper blade to the end of the wiper arm, with the adapter including a flexible tab bearing a locking button, wherein an end of the locking button is extended laterally by at least one locking lip. a retaining edge of which extends in a longitudinal direction of the adapter so as to cooperate with a lateral border of an opening in a yoke of the wiper arm so as to lock the assembly of the adapter in the yoke.
